(19) United States
(12) Patent Application Publication
(10) Pub. No.: US 2007/0149750 A1
(43) Pub. Date: Jun. 28, 2007

(54) Solid powder coating crosslinker

(75) Inventors: Richard R. Roesler, Wexford, PA (US); James W. Rawlins, Petal, MS (US); Eric J. Vidra, Pittsburgh, PA (US); Dinesh Pethiyagoda, Pittsburgh, PA (US)

Correspondence Address: BAYER MATERIAL SCIENCE LLC, 100 BAYER ROAD, PITTSBURGH, PA, 15205, US

(73) Assignee: Bayer MaterialScience LLC

(21) Appl. No.: 11/709,383

(22) Filed: Feb. 22, 2007

Related U.S. Application Data
(63) Continuation-in-part of application No. 11/126,704, filed on May 11, 2005, now abandoned.
Application No. 11/126,704 is a continuation-in-part of application No. 10/723,646, filed on Nov. 26, 2003, now abandoned.

(30) Foreign Application Priority Data
Nov. 25, 2004 (JP) 2004-340332
Nov. 25, 2004 (KR) 10-2004-9740
Nov. 22, 2004 (MX) 2004-011-587

(51) Int. Cl. C08G 18/00

(52) U.S. Cl. 528/44

(57) ABSTRACT

The present invention is directed to a friable, crystalline, fully blocked polyisocyanate prepared by reacting NTI with a pyrazole blocking agent.

### CROSS REFERENCE TO RELATED APPLICATION

This application is a continuation-in-part of U.S. application Ser. No. 11/126,704, filed on May 11, 2005, which in turn is a continuation-in-part of U.S. application Ser. Number 10/723,646, filed on Nov. 26, 2003, now abandoned.

### BACKGROUND OF THE INVENTION

Powder coatings constitute an increasing proportion of the coatings industry. The market potential for polyurethane-based powder coatings has been limited due to the crosslinkers used. One of the limitations with polyurethane-based powder coatings is the relatively high equivalent weight of the crosslinker currently used. Because of the higher equivalent weight of the crosslinker, a larger amount is needed, which increases the overall cost of the coating. A need, therefore, exists for a low equivalent weight polyurethane powder crosslinker.

Nonane triisocyanate (NTI or 4-isocyanatomethyl-1,8-octane diisocyanate) is a known material. Various uses for NTI have been suggested. See, e.g., U.S. Pat. Nos. 4,314,048; 5,714,564; 5,854,301; 6,084,051; 6,090,939; 6,100,326; 6,291,578; 6,399,691; 6,432,485; 6,433,072; 6,531,535; 6,566,444; and 6,605,669.

An article entitled “Coating Systems Based On Tricarbamate Crosslinkers Derived From Triaminonane,” (Higginbottom et al), appearing in Progress in Organic Coatings 34 (1998) pages 27-38, describes a variety of blocked NTI products. The references indicates that NTI blocked with 3,5-dimethylpyrazole is a “faint yellow, viscous liquid” (see Table 1).

### DESCRIPTION OF THE INVENTION

We have discovered that the fully blocked reaction product of NTI with a pyrazole blocking agent is a crystalline material that can be used in powder coatings as a crosslinker. The reaction product has a sharp melting point (in the case of dimethyl pyrazole, 83° C). The reaction product has the lowest equivalent weight of any of the commercially available blocked polyisocyanates.

More particularly, the present invention is directed to a crystalline, friable blocked isocyanate prepared by reacting of NTI with a pyrazole blocking agent.

The friable, crystalline product is the reaction product of the NTI and the blocking agent in a 1:1 equivalent ratio. An excess of the pyrazole blocking agent is preferably used to ensure that no isocyanate groups remain. Any remaining pyrazole is extracted by the solvent when the product crystallizes. No more than a 10% equivalent excess should be used and the amount is preferably less than 10% equivalent excess. Using high levels of the pyrazole will prevent the blocked product from crystallizing. In general, the level of pyrazole blocking agent should be from a 1% equivalent excess to a less than 10% equivalent excess, preferably from a 1% equivalent excess to a 5% equivalent excess and most preferable about a 2% equivalent excess. The % equivalent excess can be calculated according to the following formula:
[(Eq_{ba} minus Eq_{nco})/Eq_{nco}]×100, where

Eq_{ba} represents the equivalents of the pyrazole blocking agent and

Eq_{nco} represents the equivalents of isocyanate groups.

Preferred pyrazole blocking agents are selected from the group consisting of 3,5-dimethylpyrazole, 4-nitro-3,5-dimethylpyrazole, 4-benzyl-3,5-dimethylpyrazole, methyl-5-methylpyrazole-3-carboxylate, pyrazole, 3-methyl-5-phenylpyrazole, 3-methylpyrazole, 4-bromo-3,5-dimethylpyrazole and 3,5-dimethylpyrazole-4-carboxanilide, with 3,5-dimethylpyrazole being most preferred. A sufficient amount of the blocking agent is used to react with all the isocyanate groups of the NTI.

As used herein, “NTI” is intended to mean nonane triisocyanate. As is clear from the art, in addition to being called nonane triisocyanate (U.S. Pat. No. 6,084,051), nonane triisocyanate has been called i) 4-isocyanate methyl-1,8-octamethylene diisocyanate (U.S. Pat. No. 4,314,048), ii) 4-isocyantomethyl-1,8-octamethylene diisocyanate, (U.S. Pat. No. 5,714,564), iii) 4-isocyanatomethyl-1,8-octane diisocyanate (U.S. Pat. No. 6,090,939), iv) triisocyanatononane and TIN (U.S. Pat. No. 6,090,939), and v) 4-isocyanatomethyloctane-1,8-diisocyanate (U.S. Pat. No. 6,100,326).

The preferred pyrazole blocking agents are known in the art and have been described in U.S. Pat. Nos. 4,976,837, 5,246,557, 5,521,272 and 5,986,033, all the disclosures of which are hereby incorporated by reference.

Reaction times will depend on the reaction temperatures, but are typically between one and eight hours. Reaction temperatures can be from 50° C. to 120° C., with temperatures of between 60° and 80° C. being preferred to give reasonable reaction times with low color. The temperature has to be high enough to be above the melting point of the product and to give a reasonable viscosity for stirring.

The use of a solvent is essential. Substantially any solvent can be used. Especially useful solvents are those that would give limited solubility to the blocked product and would be volatile enough to be readily removed at the end of the reaction. Specifically useful solvents include ketones such as acetone, methyl ethyl ketone, and methyl isobutyl ketone; esters such as methyl acetate, ethyl acetate, butyl acetate, methyl proprionate, butyl propionate ethylene glycol ethyl ether acetate and propylene glycol methyl ether acetate; ethers such as diethyl ether and tetrahydrofuran; hydrocarbons such as benzene and toluene; dimethyl formamide; and chlorocarbons such as methylene chloride, chloroform and 1,1,1-tricloroethane. The preferred solvents are selected from acetone, ethyl acetate and methylene chloride, with acetone being the most preferred. In general the amount of solvent used should be from about 5 to about 30%, preferably from about 10 to about 20%, and most preferably from about 10 to about 15% by weight, based on the combined weight of the NTI, the blocking agent and the solvent. After the product crystallizes, the solvent can be removed by simple evaporation, e.g., a rotovap evaporator or by filtration of the solid product from the solvent. Any remaining pyrazole is extracted by the solvent when the product crystallizes.

The invention is further illustrated by the following examples in which all parts and percentages are by weight unless otherwise indicated.

### EXAMPLES

In the examples, the NTI used was a commercially available NTI having an isocyanate equivalent weight as determined by NCO end group titration of 87 (in theory, the pure NTI would have an equivalent weight of 84).

### Example 1

Preparation of Crosslinker

Into a one liter flask fitted with agitator, nitrogen inlet, thermocouple and heater were charged 203.9 parts (2.36 equivalents) of triisocyanatononane and 77 parts of acetone. Stirring was done until the solution was homogenous. The flask was at 20° C. At this time, 231.7 parts (2.41 equivalents) of powdered 3,5-dimethyl pyrazole was added at such a rate to maintain the temperature below 65° C. A strong exotherm required the use of a water/ice bath to maintain the temperature at 65° C. The reaction was cooled and held at 55° C. for an additional three hours. The NCO content by FT-IR was zero. Upon cooling, the product crystallized from solution. The material was dried. The melting point by DSC was 83° C.

Gel Time with Polyester Polyol

Gel times are used to determine the reactivity and utility of a powder coatings crosslinker. Gel times too fast prevent flow and give, for example, poor gloss. Gel times too slow would give too long a cure time for commercial utility. The material of this invention gives gel times that are ideal or intermediate for lower curing polyurethane powder coatings. The standard gel test temperature is 200° C. The low gel times with good flowout was a surprise.

Into a small blender cup was weighed 0.878 parts (0.0048 equivalents) of the crosslinker prepared above and 9.122 parts (0.0049 equivalents) of Rucote GXB 1005 a commercially available polyester polyol from Bayer Polymers LLC. [Rucote GXB 1005 is a terephthalate polyester having an OH number of 30, an acid value of about 4, a viscosity at 200° C. of 5000 cps and a T_{g} of about 60° C.] The material was ground in a blender for 30 seconds. The gel times are given in the following table:

| Temperature | Gel Time |
|---|---|
| 120° C. | 77 sec |
| 150° C. | 51 sec |

Gel time reactivity is a test method using a Coesfeld Geltest GT16 gel time meter that determines the reactivity of the coating. Gel time is the time required to pass the coating material from a solid through liquid state to a gelled state at a defined temperature. The sample is measured out using a ¼ teaspoon (approximately 0.9 grams). As the sample is placed onto the hotplate, a timer is started. The sample is stirred in a circular motion using the tip of a wooden applicator stick. As the material begins to gel, a strand can be pulled from this material by raising the applicator tip. When a stand is pulled and it breaks easily, the timer is stopped and this is the gel time reactivity of this material.

### Example 2 (Comparative)

In a first comparative example, 3,5-dimethyl pyrazole and NTI were mixed at a 1:1 equivalent ratio. The mixture was heated until the isocyanate had disappeared. Upon cooling, the mixture formed a viscous liquid. This example clearly illustrates the need for a solvent.

### Examples 3 Through 7 (Comparative)

The procedure of Example 1 was followed exactly except that 2-butoxyethanol (“2-bte”), tert-butanol (“tbt”), caprolactam (“cp”), phenol (“ph”) and 2-butanone oxime (“2-bto”) were substituted on an equivalent basis for 3,5-dimethyl pyrazole. The results were as set forth in the following table.

TABLE 1

| | | | | Viscosity, |
|---|---|---|---|---|
| Example | Blocking | | | mPaS@ |
| No. | agent | Crystallization | Appearance | 25°^{C.} |
| 3 | 2-bte | no | Clear liquid | 120 |
| 4 | tbt | no | Highly | na |
| | | | viscous oil | |
| 5 | cp | no | Highly | na |
| | | | viscous oil | |
| 6 | ph | no | Highly | na |
| | | | viscous oil | |
| 7 | 2-bto | no | Clear liquid | 8260 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A friable, crystalline, fully blocked polyisocyanate prepared by reacting NTI with a pyrazole blocking agent at an equivalent ratio of blocking groups to isocyanate groups of 1:1.

2. The blocked polyisocyanate of claim 1, wherein said blocking agent is selected from the group consisting of 3,5-dimethylpyrazole, 4-nitro-3,5-dimethylpyrazole, 4-benzyl-3,5-dimethylpyrazole, methyl-5-methylpyrazole-3-carboxylate, pyrazole, 3-methyl-5-phenylpyrazole, 3-methylpyrazole, 4-bromo-3,5-dimethylpyrazole and 3,5-dimethylpyrazole-4-carboxanilide,

3. The blocked polyisocyanate of claim 2, wherein said blocking agent is 3,5-dimethylpyrazole.

4. The blocked polyisocyanate of claim 2, wherein the reaction of the NTI and the pyrazole blocking agent is conducted in the presence of a solvent and wherein the blocking agent is used in an amount of no more a 10% equivalent excess.

5. The blocked polyisocyanate of claim 4 wherein the blocking agent is used in an amount of from a 1% equivalent excess to no more a 10% equivalent excess.

6. The blocked polyisocyanate of claim 5, wherein the blocking agent is used in an amount of from a 1% equivalent excess to a 5% equivalent excess.

7. The blocked polyisocyanate of claim 6, wherein the blocking agent is used in an amount of about a 2% equivalent excess.
